(19) United States
(12) Patent Application Publication
(10) Pub. No.: US 2008/0234932 A1
(43) Pub. Date: Sep. 25, 2008

(54) Navigation Device Having Direction Indicating Lamp

(75) Inventor: Bong-Hyoung Lee, Gangwon-do (KR)

Correspondence Address: BAKER & DANIELS LLP, 202 South Michigan Street, Suite 1400, South Bend, IN, 46601, US

(73) Assignee: CARPOINT CO., LTD., Seoul (KR)

(21) Appl. No.: 10/598,380

(22) PCT Filed: Feb. 26, 2005
(86) PCT No.: PCT/KR2005/000539

§ 371 Date: Sep. 6, 2006

(30) Foreign Application Priority Data
Feb. 27, 2004 (KR) 20-2004-0005338

(51) Int. Cl. G01C 21/00

(52) U.S. Cl. 701/213

(57) ABSTRACT

Disclosed is a navigation device loaded in a vehicle to output vehicle navigation information corresponding to a signal received from GPS (Global Positioning System). The navigation device includes a body including a display for displaying the vehicle navigation information, and a controller for calculating a current location of the vehicle with respect to a previously set destination and outputting a turning direction instructing signal; and a pair of light emitting members installed to the body so that right and left are distinguishable, the pair of light emitting members selectively emitting light in correspondence to the turning direction instructing signal output from the controller.

### TECHNICAL FIELD

The present invention relates to a navigation device for providing vehicle navigation information, and more particularly to a navigation device capable of contriving convenience and safety of a moving vehicle by giving improved discernment for instruction information about a turning direction, generated in the navigation device according to a signal received from GPS (Global Positioning System).

### BACKGROUND ART

Generally, a navigation device loaded in a vehicle is a terminal that receives navigation information such as location and speed of a vehicle from GPS and then displays the information on a predetermined display. Such a navigation device is very useful as a driving assistance means on a first strip or on a complicated road.

In addition to displaying the navigation information, the navigation device is recently provided with various additional functions such as a traffic status displaying function for displaying a traffic statue of surroundings and a direction guiding function for guiding a direction to be turned according to the route toward a destination previously set by a user, thereby contriving convenience in driving a vehicle.

In such a navigation device, the direction guiding function may be realized in a way that a corresponding point is marked in the map displayed on the display when a left turn or a right turn is needed while a vehicle is in motion toward a set destination. However, this method marks a turning direction in a very small area on the map, so it is not easy to distinguish a mark between the right and left turns. This may cause an accident since the driver should fix his/her eyes on the display carefully so as to identify the mark.

As an alternative, there is also proposed a product that outputs the turning direction guidance of a vehicle in voice. However, this method has a problem that a driver may forget the voice guidance at a turning point since the voice service is given to the driver in advance. In addition, if the voice guidance is output repeatedly, it may be noisy.

### DISCLOSURE OF INVENTION

### Technical Problem

The present invention is designed to solve the problem of the prior art, and therefore an object of the invention is to provide a navigation device capable of giving an improved discernment for a turning direction of a moving vehicle by displaying turning direction instructing information on indicators installed at two areas on a body of the navigation device, separately from a display.

Another object of the invention is to provide a navigation device having an attachment member for attaching a cellular phone to the body conveniently.

### Technical Solution

In order to accomplish the above object, the present invention provides a navigation device loaded in a vehicle to output vehicle navigation information corresponding to a signal received from GPS (Global Positioning System), which includes a body including a display for displaying the vehicle navigation information, and a controller for calculating a current location of the vehicle with respect to a previously set destination and outputting a turning direction instructing signal; and a pair of light emitting members installed to the body so that right and left are distinguishable, the pair of light emitting members selectively emitting light in correspondence to the turning direction instructing signal output from the controller.

The light emitting members may be installed to both sides of the body, respectively.

As an alternative, the light emitting members may be installed within, partially within, or out of a front portion of the body.

Additionally, the navigation device of the present invention may further include an attachment member selectively slidably drawn out on one side of the body and having an attachment surface for seating a cellular phone thereon; and a fixing member provided to one side of the attachment member to fix the attached cellular phone.

Preferably, the fixing member is made of a magnet so as to fix a cellular phone having a metal member on a rear surface thereof.

### ADVANTAGEOUS EFFECTS

When using the navigation device, direction indicating lamps may be separately provided to the body of the navigation device and selectively operated according to the navigation information. It allows a driver to recognize a turning point in a convenient and accurate way, and thus it is possible to contrive convenience and safety while a vehicle is driving.

In addition, since a cellular phone may be attached to the attachment member that is selectively drawn out from the body of the navigation device, a user may conveniently keep and use a cellular phone in the vehicle. It also allows various additional functions by connecting the cellular phone to the navigation device.

Moreover, the navigation device of the present invention also has an advantage that a turning direction may be indicated using various colors and various light emitting patterns together with a minimal voice guidance required for turning of the vehicle.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a front view showing a navigation device according to one embodiment of the present invention;

FIG. 2 is a circuit diagram showing an example of functional configuration of the navigation device according to the present invention;

FIG. 3 is a front view showing a navigation device according to another embodiment of the present invention; and

FIG. 4 shows that the navigation device of the present invention is in use, as an example.

### BEST MODE FOR CARRYING OUT THE INVENTION

Hereinafter, preferred embodiments of the present invention will be described in detail referring to the accompanying drawings.

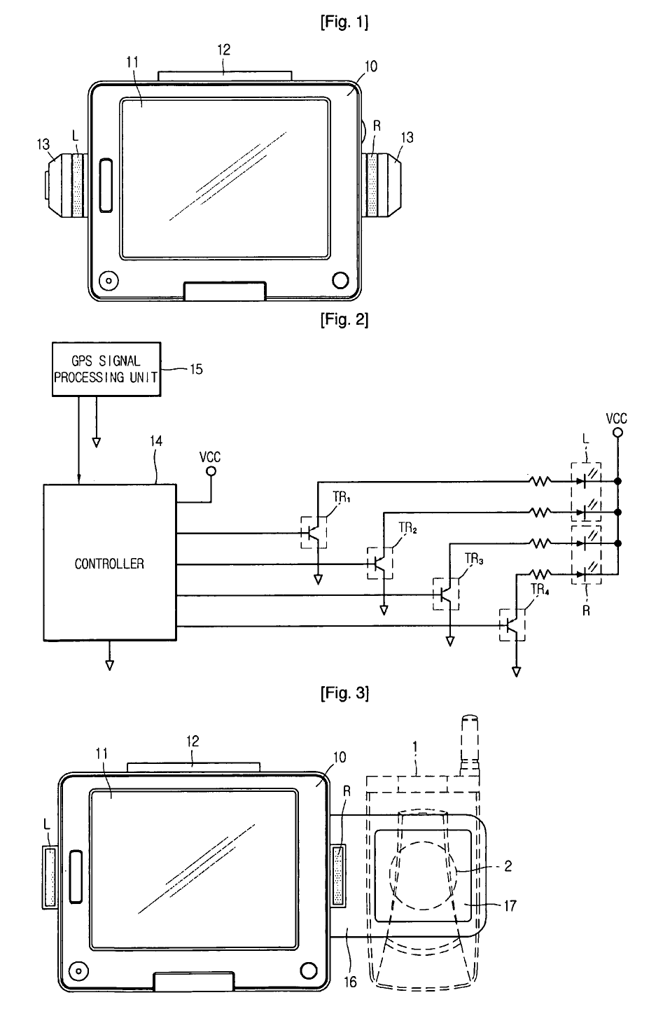

FIG. 1 is a perspective view showing a navigation device according to one embodiment of the present invention.

Referring to FIG. 1, the navigation device of the present invention includes a body 10 having a display 11 and a controller 14, and a pair of light emitting members L and R formed on an outer portion of the body 10 so that their right and left are distinguishable.

The display 11 is provided to the front surface of the body 10 so as to display vehicle navigation information corresponding to a map data and a signal received from GPS. The display 11 may adopt a LCD or other equivalents. Here, the map data displayed on the display 11 may be stored in a CF (Compact Flash) card inserted into a predetermined slot (not shown) in one side of the body 10. In addition, in order to receive GPS signals, the body 10 may have a general GPS antenna 12 at one side thereof.

A pair of the light emitting members L and R selectively operated by the controller 14 in the body 10 are installed to the body 10 so that their right and left may be distinguished. Preferably, the light emitting members L and R mounted to both sides of the body 10 respectively instruct a right or left turn. As an alternative, the light emitting members L and R may be installed within the front portion of the body 10, installed partially within the front portion of the body 10, or installed out of the front portion of the body 10, selectively. Here, in case of being installed within the body 10, the light emitting members L and R have surfaces positioned on the same plane as the front portion of the body 10. In case of being installed partially within the body 10, the light emitting members L and R are partially inserted into the front portion of the body 10 and their surfaces are partially protruded out from the front portion of the body 10.

As the light emitting members L and R, LED (Light Emitting Diode) capable of emitting various colors of light with low energy consumption may be preferably configured in single or in an array. However, it should be understood that the light emitting members L and R may use other kinds of light emitting members already known, not limited to LED.

FIG. 2 schematically shows a functional configuration of the navigation device according to the present invention for selectively operating the light emitting members L and R according to the navigation information. As shown in FIG. 2, the navigation device of the present invention includes the controller 14 for receiving current navigation information from a GPS signal processing unit 15, calculating a current location of a vehicle with respect to a previously set destination, predicting a course of the vehicle such as a right turn and a left turn on the basis of the calculation, and then selectively turning on or off a pair of the light emitting members L and R according to the prediction. A processing module included in a general navigation device to conduct the same function may be used as the controller 14.

More specifically, the controller 14 applies an operating signal to TR₁ and TR₂ when a vehicle should be turned left after a predetermined time (or, a predetermined distance) according to the calculation result so that the light emitting member L for instructing a left turn is turned on or periodically flickering. In contrast, when a right turn is needed, the controller 14 applies an operating signal to TR₃ and TR₄ so as to instruct a corresponding direction by turning on or periodically flickering the light emitting member R for instructing a right turn. Additionally, the controller 14 may be configured to operate a pair of the light emitting members L and R in a certain pattern in correspondence with traffic conditions such as a U-turn, an elevated driveway, an underpass and a monitoring camera.

In the case that LED is adopted for the light emitting members L and R, the light emitting members L and R may be configured with an LED array having a circular light emitting pattern, combined to a substantially cylindrical case. In other cases, the light emitting members L and R may be configured with an LED array having a light emitting pattern like a bar as shown in FIG. 3. Here, configuration of the light emitting members L and R is not limited to this embodiment, but many modifications may be applied thereto.

Preferably, an attachment member 16 with a plate shape may be slidably installed to a rear side, or a side adjacent to the rear side, of the body 10 so that it may be selectively drawn out on one side of the body 10. The attachment member 16 is used for attaching a cellular phone 1 thereto and has an attachment surface for seating the cellular phone 1 thereon. A fixing member 17 is provided to one side of the attachment surface so as to firmly fix the cellular phone 1. Here, the fixing member 17 is preferably made of a magnet, so a cellular phone 1 having a metal member 2 or a magnet on its rear side may be attached in a compact structure.

In addition, the body 10 may provide various additional functions by having an adjustment button for adjusting a size of a displayed screen and a voice input/output means such as a microphone, a speaker and a volume button. Such components are not described in detail here since there are also provided in a general navigation device.

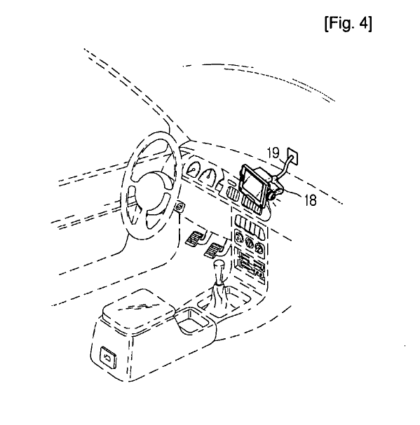

FIG. 4 shows an example of the navigation device according to the present invention in use. As shown in FIG. 4, the navigation device of the present invention includes a combination member 18 at the rear side thereof, and a fixture 19 of a pre-determined length combined to the combination member 18 so as to be fixed to a portion of the inside of a vehicle. Thus, the navigation device may be mounted to the inside of a vehicle in a convenient way.

In the present invention, the light emitting members L and R are installed to both sides of the body 10 to instruct a left or right turn. Thus, after a predetermined time (or, a predetermined distance) since the controller 14 calculates mutual relation between the set destination and the current vehicle location, if a right turn is required, the controller 14 applies an operating signal only to the light emitting member R for instructing a right turn selectively so that the light emitting member R emits light. At this time, the light emitting members L and R may have various light emitting patterns. For example, the light emitting members L and R may keep a turning-on state or may be flickering periodically, and various light emitting patterns and colors may be applied to the light emitting members L and R.

In addition, the navigation device of the present invention may be provided with the attachment member 16 for a cellular phone so that a cellular phone 1 may be attached to one side of the body 10 of the navigation device in a convenient way. That is to say, if a user draws the attachment member 16 of a plate shape on the side of the body 10 and then contacts the metal member 2 provided on the rear side of a specific cellular phone 1 to a portion corresponding to the fixing member 17 preferably made of a magnet, the cellular phone 1 may be firmly seated on the surface of the attachment member 16 by means of a magnetic force.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to the present invention, direction indicating lamps are separately provided to the body of the navigation device and selectively operated according to the navigation information, so a driver may recognize a turning point in a convenient and accurate way, and thus it is possible to contrive convenience and safety while a vehicle is driving.

In addition, since a cellular phone may be attached to the attachment member that is selectively drawn out from the body of the navigation device, a user may conveniently keep and use a cellular phone in the vehicle, and it also allows various additional functions by connecting the cellular phone to the navigation device.

Moreover, the navigation device of the present invention also has an advantage that a turning direction may be indicated using various colors and various light emitting patterns together with a minimal voice guidance required for turning of the vehicle.

1. (canceled)

2. A navigation device, which includes a body loaded in a vehicle and provided with a display for displaying vehicle navigation information corresponding to a signal received from GPS (Global Positioning System) and a controller for calculating a current location of the vehicle with respect to a previously set destination and outputting a turning direction instructing signal of the vehicle, the navigation device comprising:
a pair of light emitting members protrusively installed on both side ends of the body so that right and left are distinguishable, the pair of light emitting members selectively emitting light in correspondence to the turning direction instructing signal output from the controller.

3. (canceled)

4. The navigation device according to claim 2, further comprising:
an attachment member selectively slidably drawn out on one side of the body and having an attachment surface for seating a cellular phone thereon; and
a fixing member provided to one side of the attachment member to fix the attached cellular phone.

5. The navigation device according to claim 4, wherein the fixing member is made of a magnet so as to fix a cellular phone having a metal member on a rear surface thereof.
